(19) United States
(12) Patent Application Publication
(10) Pub. No.: US 2025/0265858 A1
(43) Pub. Date: Aug. 21, 2025

(54) INFORMATION PROCESSING APPARATUS AND METHOD

(71) Applicant: TOYOTA JIDOSHA KABUSHIKI KAISHA, Toyota-shi Aichi-ken (JP)

(72) Inventors: Mitsuhiro MIURA, Toyota-shi Aichi-ken (JP); Yoshiaki TOMATSU, Toyoake-shi Aichi-ken (JP)

(73) Assignee: TOYOTA JIDOSHA KABUSHIKI KAISHA, Toyota-shi Aichi-ken (JP)

(21) Appl. No.: 19/049,030

(22) Filed: Feb. 10, 2025

(30) Foreign Application Priority Data
Feb. 21, 2024 (JP) 2024-024396

(51) Int. Cl. G06V 40/10; B60K 35/28; G06V 20/59; G06V 40/20

(52) U.S. Cl. CPC G06V 40/10; B60K 35/28; G06V 20/59; G06V 40/20; B60K 2360/741

(57) ABSTRACT

A controller includes at least one processor of an information processing apparatus acquires a number of standing passengers in a vehicle. The controller of the information processing apparatus determines whether to execute the detection process of passengers moving inside the vehicle based on analysis of a moving image capturing the inside of the vehicle according to the number of standing passengers. Then, the controller outputs announcement information for making an in-vehicle announcement regarding movement inside the vehicle when the detection process detects a standing passenger moving inside the vehicle.

### CROSS REFERENCE TO THE RELATED APPLICATION

This application claims the benefit of Japanese Patent Application No. 2024-024396, filed on Feb. 21, 2024, which is hereby incorporated by reference herein in its entirety.

### BACKGROUND

### Technical Field

The present disclosure relates to an information processing apparatus and a method.

### Description of the Related Art

Japanese Patent Application Laid-open No. 2022-94724 discloses a monitoring system. In the monitoring system, images taken of each compartment of multiple moving bodies are obtained. In the monitoring system, based on the obtained images, the amount of movement of passengers present in each compartment of the multiple moving bodies is acquired. In the monitoring system, based on the obtained movement amount, the priority indicating the necessity of monitoring the passengers is calculated. Then, in the monitoring system, the target for display to a display device that sequentially switches the images of each compartment of multiple moving bodies during the display switching period is determined based on the priority.

### SUMMARY

This disclosure aims to suppress in-vehicle announcements for alerting passengers about movements inside the vehicle in unnecessary situations.

An information processing apparatus, according to the present disclosure, includes a controller comprising at least one processor configured to perform;
acquiring a number of standing passengers in a vehicle,
determining whether to execute the detection process of passengers moving inside the vehicle based on analysis of a moving image capturing the inside of the vehicle according to the number of standing passengers, and
outputting announcement information for making an in-vehicle announcement regarding movement inside the vehicle when the detection process detects a standing passenger moving inside the vehicle.

This disclosure allows for the suppression of onboard announcements that alert passengers about moving within the vehicle in unnecessary situations.

### BRIEF DESCRIPTION OF THE DRAWINGS

FIG. 1 is a diagram illustrating the outline structure of the monitoring system,

FIG. 2 demonstrates an example of a moving image taken by an in-vehicle camera,
FIG. 3 is a block diagram schematically illustrating an example of the functional configuration of an in-vehicle device,

FIG. 4 is a flowchart of the first process, and
FIG. 5 is a flowchart of the second process.

### DESCRIPTION OF THE EMBODIMENTS

There are cases where a passenger inside the vehicle may fall while moving inside the vehicle. Therefore, when the movement of passengers inside the vehicle is detected, an in-vehicle announcement alerting the passengers about the movement may be made. Here, it is envisioned that the movement of passengers in the vehicle is detected through analysis of the moving images taken by the cameras installed in the vehicle.

When there are many standing passengers (hereinafter occasionally referred to as “standing passengers”) inside the vehicle, the distance between the standing passengers becomes shorter compared to when there are fewer standees. Therefore, when there are many standing passengers compared to when there are few standing passengers, it is more likely that the recorded moving images of overlapping standing passengers will be captured by cameras installed inside the vehicle. At this time, due to overlapping standing passengers within the moving images, it becomes difficult to distinguish the contours of different standing passengers during the moving image analysis.

Thus, during the video moving image analysis, it may sometimes recognize two different standing passengers as the same individual. In this case, within the captured moving image, one standing passenger's position might be recognized as the position of two standing passengers treated as the same individual. At this time, in the next frame, if the position of the another standing passenger is recognized as the position of two standing passengers of the same person, it is recognized that the position of the two standing passengers of the same person has moved from the one standing passenger's position to the another standing passenger's position. As a result, there may be cases where it is mistakenly recognized that the standing passenger is moving. Thus, compared to when there are fewer standing passengers, there is a higher likelihood of incorrect detection of a standing passenger moving within the vehicle when there are many standing passengers.

Additionally, when there are many standing passengers compared to fewer, the space to move inside the vehicle is smaller, thus restricting movement within the vehicle. Therefore, if the movement of a standing passenger is detected when there are many standing passengers, it is assumed that the probability of such detection being incorrect is higher than when there are fewer.

A controller comprising at least one processor of an information processing apparatus, according to the present disclosure, acquires a number of standing passengers in a vehicle. The controller of the information processing apparatus determines whether to execute the detection process of passengers moving inside the vehicle based on analysis of a moving image capturing the inside of the vehicle according to the number of standing passengers. Then, the controller outputs announcement information for making an in-vehicle announcement regarding movement inside the vehicle when the detection process detects a standing passenger moving inside the vehicle.

As explained above, the information processing apparatus determines the feasibility of performing detection process according to the number of standing passengers. This suppresses the execution of detection process in situations where standing passengers might be mistakenly detected as moving. Additionally, the execution of the detection process is restricted in situation where in-vehicle movement is already limited. As a result, it is possible to suppress the output of announcement information in these circumstances. Thus, it is possible to suppress in-vehicle announcements encouraging awareness of movement within the vehicle by passengers unnecessary situations.

The detailed embodiments of this disclosure will be explained below with reference to the drawings. Unless stated otherwise, the hardware configuration, module configuration, and functional configuration described in the various embodiments are not intended to limit the technical scope of the disclosure.

### Embodiment

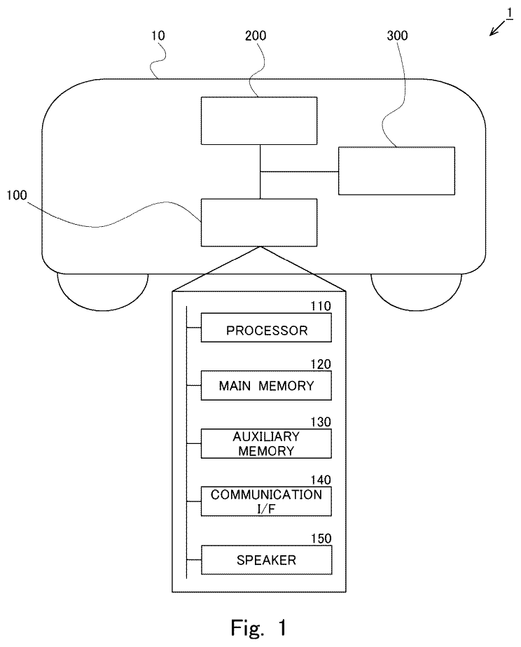

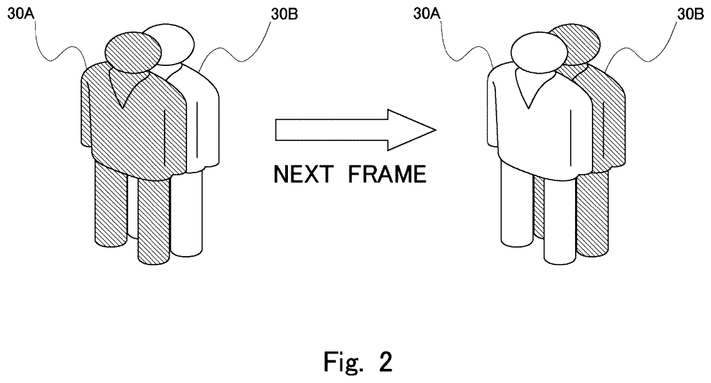

A monitoring system 1 of this embodiment will be explained based on FIGS. 1 and 2. FIG. 1 is a diagram illustrating the schematic structure of the monitoring system 1. The monitoring system 1 constitutes an in-vehicle device 100, an in-vehicle camera 200, and an acceleration sensor 300. In monitoring system 1, in-vehicle device 100, in-vehicle camera 200, and acceleration sensor 300 are interconnected through the in-vehicle network.

### In-Vehicle Camera

The in-vehicle camera 200 is a camera provided within the vehicle 10. Here, vehicle 10 is a vehicle that can accommodate multiple passengers. Also, within the vehicle 10, passengers can stand. In this embodiment, the vehicle 10 is a bus. Note that the vehicle 10 may be other vehicles than a bus, as long as it is capable of carrying multiple passengers and allowing passengers to stand. For instance, the vehicle 10 may also be a train car.

The in-vehicle camera 200 images the inside of the vehicle 10. The in-vehicle camera 200 is installed at the top of the vehicle 10. The in-vehicle camera 200 then overlooks the passengers of the vehicle 10. Thus, the in-vehicle camera 200 can image the entirety of the inside of the vehicle 10. In-vehicle camera 200 transmits the captured moving images to the in-vehicle device 100 real-time through the in-vehicle network.

The acceleration sensor 300 is a sensor that detects acceleration. The acceleration sensor 300 transmits the detected acceleration to the in-vehicle device 100 real-time through the in-vehicle network. Thus, in-vehicle device 100 can comprehend the acceleration of vehicle 10.

### In-Vehicle Device

The in-vehicle device 100 is installed within vehicle 10. The in-vehicle device 100 provides output (such as display or audio output on a screen) corresponding to various pieces of information to the passengers of vehicle 10. Here, there are instances where passengers of the vehicle 10 may fall down while moving within the vehicle 10. Therefore, when the passengers of vehicle 10 are moving within the vehicle, in-vehicle device 100 announces an alert about in-vehicle movement to the passengers of vehicle 10.

The in-vehicle device 100 performs a process to detect the movement of passengers in the vehicle 10 by analyzing the moving image captured by the in-vehicle camera 200 (hereinafter sometimes referred to as “detection process”). Specifically, in the detection process, the in-vehicle device 100 identifies the contours of the passengers imaged in the moving images and specifies their positions. Then, the in-vehicle device 100 detects the movement of the passenger within the vehicle 10 by determining whether the position of the identified passenger has moved during the detection process.

At this time, when there are many standing passengers in vehicle 10 (hereinafter sometimes referred to as “standing passengers”), the distance between the standing passengers becomes shorter compared to when there are fewer standing passengers. Therefore, when there are many standing passengers compared to when there are few standing passengers, it is more likely that the recorded moving images of overlapping standing passengers will be captured by cameras installed inside the vehicle.

FIG. 2 is a diagram illustrating an example of a moving image within the vehicle 10 captured by the in-vehicle camera 200. In the moving image shown in FIG. 2, standing passenger 30A is positioned in front of standing passenger 30B, capturing the situation where standing passenger 30A and standing passenger 30B are overlapping. In this case, because standing passenger 30A and standing passenger 30B are overlapping in the moving image, it becomes difficult for the in-vehicle device 100 to distinguish the contours of standing passenger 30A and standing passenger 30B during moving image analysis.

Hence, it is possible that the in-vehicle device 100 may recognize standing passengers 30A and 30B as the same person during the moving image analysis. In the example shown in FIG. 2, the in-vehicle device 100 first recognizes standing passenger 30A as standing passengers 30A and 30B as the same person. Next, in the following frame, the in-vehicle device 100 recognizes standing passenger 30B as standing passengers 30A and 30B as the same person.

In other words, the positions of standing passenger 30A and standing passenger 30B of the same person are first recognized at the position of standing passenger 30A (hatched area on the left side of FIG. 2). Then, in the next frame, they are recognized at the position of standing passenger 30B (hatched area on the right side of FIG. 2). As a result, the in-vehicle device 100 recognizes that standing passengers 30A and 30B as the same person have moved from the position of standing passenger 30A to the position of standing passenger 30B between frames. Thus, compared to when there are fewer standing passengers, there is a higher likelihood of incorrect detection of a standing passenger moving when there are many standing passengers.

Additionally, when there are many standing passengers compared to fewer, the space inside vehicle 10 available for moving is smaller, restricting movement within the vehicle. Therefore, even if the movement of a standing passenger is detected when there are many standing passengers, compared to when there are fewer, it is assumed that the probability of such detection being incorrect is higher.

Thus, the in-vehicle device 100 obtains the number of standing passengers in vehicle 10 (hereinafter possibly referred to as “number of standing passengers”). The in-vehicle device 100 determines whether to execute the detection process based on the number of standing passengers. When in-vehicle device 100 detects standing passengers moving inside the vehicle during the detection process, it makes an in-vehicle announcement to alert passengers about the movement. The details of how the in-vehicle device 100 determines whether to execute the detection process and how the in-vehicle announcement is conducted will be described later.

The in-vehicle device 100 consists of a computer having a processor 110, main memory 120, auxiliary memory 130, and a communication interface (communication I/F) 140. The processor 110 is, for example, a CPU (Central Processing Unit) or a DSP (Digital Signal Processor). The main memory 120 is, for example, RAM (Random Access Memory). The auxiliary memory 130 is, for example, ROM (Read Only Memory). Also, the auxiliary memory 130 is, for example, a disk recording medium such as an HDD (Hard Disk Drive), or a CD-ROM, DVD disk, or Blu-ray disc. In addition, the auxiliary memory 130 may also be a removable medium (portable storage medium). Here, for example, a USB memory or an SD card is illustrated as a removable medium. The communication I/F 140 is, for example, a LAN (Local Area Network) interface board. The speaker 150 is a speaker provided in the vehicle 10.

In the in-vehicle device 100, the auxiliary memory 130 stores the operating system (OS), various programs, and various information tables, etc. Furthermore, the in-vehicle device 100 realizes various functions described later by having the processor 110 load the programs stored in the auxiliary memory 130 into the main memory 120 and execute them. However, part or all of the functions in the in-vehicle device 100 may be implemented by hardware circuits such as ASICs or FPGAS. Moreover, the in-vehicle device 100 does not necessarily have to be realized by a single physical structure and may be composed of multiple computers that work together.

### Functional Configuration

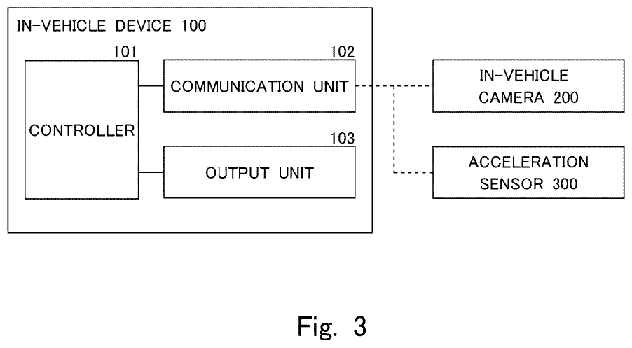

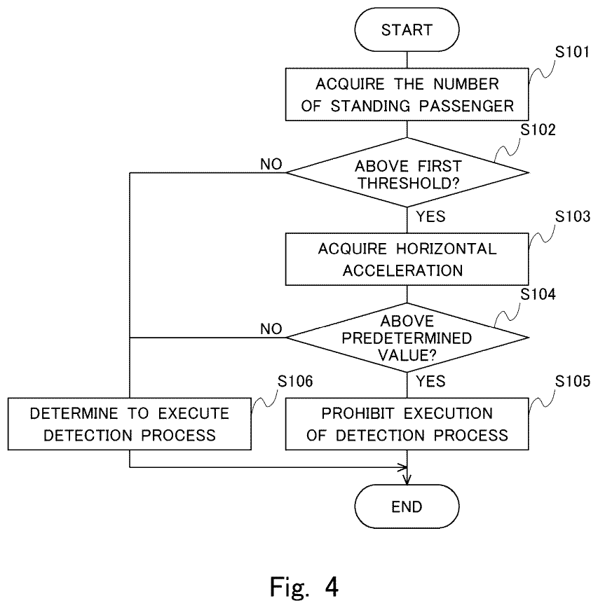

Next, the functional configuration of the in-vehicle device 100 that constitutes the monitoring system 1 according to this embodiment will be explained based on FIG. 3. FIG. 3 is a block diagram schematically illustrating an example of the functional configuration of the in-vehicle device 100.

The in-vehicle device 100 includes a controller 101, a communication unit 102, and an output unit 103. The controller 101 has the function of performing computational processing to control the in-vehicle device 100. The controller 101 can be realized by a processor 110 in the in-vehicle device 100. The communication unit 102 has the function of connecting the in-vehicle device 100 to an in-vehicle network. The communication unit 102 can be realized by the communication I/F 140 in the in-vehicle device 100. The output unit 103 has the function of outputting audio within the vehicle 10. The output unit 103 can be realized by the speaker 150 in the in-vehicle device 100. The output unit 103 may also have a function to display images, etc. by a display provided in the vehicle 10.

The controller 101 receives moving images inside vehicle 10 from the in-vehicle camera 200 via the communication unit 102. The controller 101 obtains the number of standing passengers in vehicle 10 by analyzing the moving images inside vehicle 10. Specifically, the controller 101 identifies the position of the standing passengers in the vehicle 10 by specifying the position of characteristic points (for example, the head) of the passengers as their location based on the moving image analysis. Then, the controller 101 identifies the passengers located within the area where standing riding is performed as standees and counts the number of standing passengers.

Furthermore, the controller 101 will monitor the positions of the identified standing passengers. By referring to this position, controller 101 executes the detection process. Specifically, in the detection process, the controller 101 determines that the standing passenger is moving within the vehicle 10 if the position of the standing passenger has moved a predetermined distance within a predetermined time. In other words, the controller 101 determines that a standing passenger is moving within the vehicle 10 when the passenger's head moves a certain distance within a predetermined time during detection process processing.

On the other hand, as previously mentioned, the probability of incorrect movement detection is higher with many standing passengers compared to fewer. Additionally, when there are many standees, there is a higher possibility that the detection of standee movement is a false positive compared to when there are fewer standees. Therefore, the controller 101 determines whether the number of standees is equal to or greater than a first threshold value. Here, the first threshold value is a value determined according to the density of passengers in the vehicle 10. The first threshold value is determined by multiplying the area of the boarding part of the vehicle 10 by a predetermined density. The predetermined density is a density assumed to be dependent on the in-vehicle camera 200 capturing a moving image of standing passengers overlapped with each other, and is defined by the density at which the movement of standing passengers inside the vehicle is assumed to be restrained.

The controller 101 obtains the acceleration of the vehicle 10 from the acceleration sensor 300 via the communication unit 102. The controller 101 acquires the horizontal acceleration of the vehicle 10 (hereinafter also referred to as “horizontal acceleration”) as the acceleration of the vehicle 10. Here, when the horizontal acceleration of the vehicle 10 is large, the standing passengers stagger or their upper bodies shake compared to when the horizontal acceleration of the vehicle 10 is small. Therefore, even when standing passengers are not moving, there are times when their heads move the predetermined distance within the predetermined time due to the sway. Therefore, if the horizontal acceleration is such that the standing passengers stagger or their upper bodies shake, the possibility of misdetecting the standing passengers as moving within the vehicle increases compared to when that is not the case.

Thus, the controller 101 decides to prohibit the execution of the detection process when the number of standing passengers is equal to or above the first threshold, and the horizontal acceleration is equal to or above a predetermined value. The predetermined value is set as the acceleration assumed for the stagger or upper body shake of the standing passengers in the vehicle 10. Even if the number of standing passengers is above the first threshold, there may be passengers moving within the vehicle. Thus, controller 101 decides to execute the detection process when the number of standing passengers is equal to or above the first threshold, and the horizontal acceleration is less than a predetermined value. Additionally, controller 101 decides to execute the detection process when the number of standing passengers is less than the first threshold.

Also, the controller 101 may decide to prohibit the execution of the detection process when the number of standing passengers exceeds the first threshold and the horizontal acceleration exceeds the predetermined value. At this time, the controller 101 decides to execute the detection process when the number of standing passengers exceeds the first threshold, and the horizontal acceleration is less than the predetermined value. Furthermore, controller 101 decides to execute the detection process when the number of standing passengers is below the first threshold. In this scenario, controller 101 can make any decision about the execution of the detection process when the number of standing passengers equals the first threshold or there is a horizontal acceleration equal to the predetermined value.

Once the controller 101 decides to execute the detection process, the detection process begins. The controller 101 conducts an in-vehicle announcement (hereafter possibly simply referred to as “in-vehicle announcement”) via the output unit 103 for raising awareness about moving within the vehicle when it detects standing passengers moving during the detection process.

Here, the more the number of standing passengers, the higher the possibility of false detection during the detection process. Therefore, the controller 101, when detecting movement of standing passengers in the vehicle during the detection process, makes different in-vehicle announcements depending on whether the potential for false detection is high or low according to the number of standing passengers.

Specifically, if the number of standing passengers exceeds the second threshold, the controller 101 outputs cautionary behavior information to make announcements to alert the behavior of the vehicle. An announcement to draw attention to the behavior of the vehicle is, for example, an announcement about the shaking of the vehicle 10 while in motion.

Furthermore, if the number of standing passengers is below the second threshold, the controller 101 outputs safety action information to announce a predetermined action for safety. The predetermined action is, for example, sitting on a seat. Also, the predetermined action is, for example, grasping a strap handle. Additionally, the predetermined action could also be standing at the current position without moving inside the vehicle. Note that the second threshold value may be the same as or smaller than the first threshold value.

In this way, the controller 101 outputs either cautionary behavior information or safety action information according to the number of standing passengers. Here, the content of in-car announcements due to the output of safety action information is more direct in alerting standing passengers of their movement within the vehicle than the content of announcements due to cautionary behavior information. In this way, indirect caution is provided when there is a high possibility of false detection in the detection process, and direct caution is given when there is a low possibility of false detection in the detection process. This suppresses the in-vehicle announcement of direct caution when a detection in the detection process is a false detection, thereby preventing passengers from feeling uncomfortable.

### First Processing

The first process executed by the controller 101 in the in-vehicle device 100 of the monitoring system 1 will be explained based on FIG. 4. FIG. 4 is a flowchart illustrating the first processing. The first process is to decide whether to execute the detection process. The first process is repeatedly executed at a predetermined interval. The first processing is executed when the vehicle 10 is running.

In the first process, in S101, the number of standing passengers in the vehicle 10 is acquired. Next, in S102, it is determined whether or not the number of standing passengers is above the first threshold. If a negative judgment is made in S102, it is presumed that the possibility of false detection of movement inside the vehicle during the detection process is lower than what occurs during a positive judgment. Therefore, the execution of the detection process is determined in S106. Then, the first process is temporarily terminated.

When a negative judgment is made in S102, the horizontal acceleration is acquired from the acceleration sensor 300 in S103. Next, in S104, it is determined whether the acquired horizontal acceleration is equal to or greater than the predetermined value. In S104, if the decision is negative, the number of standing passengers is above the first threshold, and the horizontal acceleration is below a predetermined value. Therefore, although the likelihood of misdetection of movement inside the vehicle during the detection process is higher than when a negative judgment is made in S102, it is lower than when an affirmative judgment is made in S104. Consequently, the execution of the detection process is determined in S106. Then, the first process is temporarily terminated.

In S104, if the decision is affirmative, the number of standing passengers is above the first threshold, and the horizontal acceleration is above a predetermined value. Therefore, the possibility of false detection in the detection process is presumed to be higher compared to when a negative judgment was made. Therefore, in S105, it is decided to prohibit the execution of the detection process. Then, the first process is temporarily terminated.

### Second Process

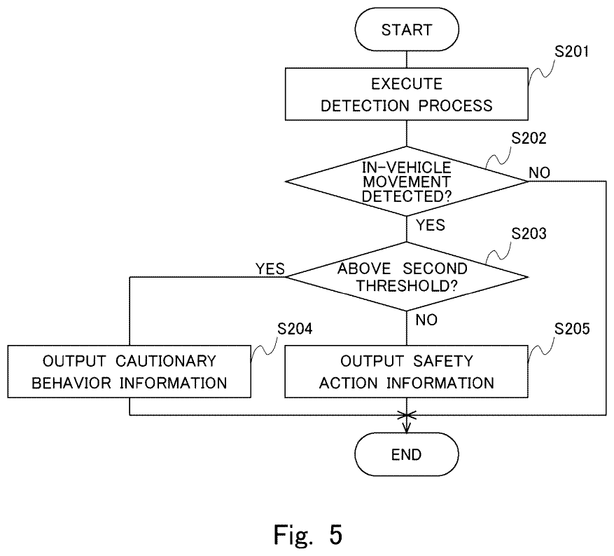

Next, the second process executed by the controller 101 in the in-vehicle device 100 of the monitoring system 1 will be explained based on FIG. 5. FIG. 5 is a flowchart of the second process. The second process executes a detection process and outputs cautionary behavior information or safety action information when there are standing passengers moving inside the vehicle 10. The second process begins execution if it is determined in S106 of the first process that the detection process should be executed.

In the second process, in S201, the detection process using moving image analysis is executed. Then, in S202, it is determined whether in-vehicle movement has been detected in the detection process. Specifically, in the detection process, it is determined whether the standing passenger has moved more than a predetermined distance within a certain period. Then, in S203, it is determined whether or not the number of standing passengers is above the second threshold. If a positive determination is made in S203, cautionary behavior information is output in S204. In other words, in S204, cautionary behavior information is output instead of safety action information. Then, the second process is terminated. Also, if the negative judgment is made in S203, safety action information is output in S205. In other words, in S205, safety action information is output rather than behavior caution information. Then, the second process is terminated.

As explained above, it is determined whether or not to execute the detection process according to the number of standing passengers using the monitoring system 1. This suppresses the execution of the detection process in situations where there is a high likelihood of a standee being falsely detected as moving. Additionally, the execution of the detection process is suppressed in situations where movement within the vehicle 10 has been suppressed. Therefore, in these situations, it is possible to suppress in-vehicle announcement. In this way, it is possible to suppress in-car announcements that alert passengers about movement within the vehicle 10 in unnecessary situations.

### Modified Example 1

In this embodiment, the in-vehicle device 100 decides to execute the detection process if the number of standees is above the first threshold and the horizontal acceleration is below the predetermined value. On the other hand, in this modified example, the in-vehicle device 100 decides to prohibit the execution of the detection process if the number of standees is above the first threshold. In other words, the in-vehicle device 100 decides to prohibit the execution of the detection process if the number of standees is above the first threshold, and to execute the detection process if the number of standees is below the first threshold.

As a result, regardless of the horizontal acceleration, the detection process will not be executed in situations where there is a high possibility of being falsely detected as moving, and the standing passengers' movement inside the vehicle 10 is suppressed. By doing so, it is possible to suppress in-vehicle announcements that alert passengers about movement within the vehicle 10 in unnecessary situations. Note that, in this modified example, the second threshold is set to a value smaller than the first threshold because the detection process is not executed when the number of standing passengers is above the first threshold.

### Modified Example 2

As described above, the more standing passengers there are, the higher the possibility of false detection in the detection process. Therefore, the more standing passengers there are, the higher the possibility of unnecessary in-vehicle announcements. Moreover, if the cautionary behavior information or safety action information is output every time in-vehicle movement is detected in the detection process, an in-car announcement will be made every time even if in-vehicle movement is misdetected. Therefore, it is conceivable that passengers of vehicle 10 would sense discomfort due to repeated in-vehicle announcements despite no movement inside the vehicle. Additionally, even if cautionary behavior information or safety action information is not output every time in-vehicle movement is detected in the detection process, passengers of the vehicle 10 can recognize that alerts related to in-vehicle movement are being issued if these pieces of information are announced a certain number of times.

Therefore, the in-vehicle device 100 limits the number of times cautionary behavior information or safety action information is output within a predetermined period when the number of standing passengers exceeds the third threshold, which is below the first threshold. Here, the third threshold may be the same value as the second threshold, or it may be a different value.

At this time, during the period when vehicle 10 is moving between bus stops, the passengers of vehicle 10 do not change. As a result, it is assumed that sufficient in-vehicle announcements can be made while the vehicle 10 is moving between bus stops by performing the predetermined number of in-vehicle announcements. Therefore, the predetermined period is set as the period during which the vehicle 10 moves between bus stops. Moreover, the predetermined period may be, for instance, a period determined by a predetermined length of time. By doing so, unnecessary in-vehicle announcements alerting attention under situations with a high possibility of false detection in the detection process can be suppressed.

### Modified Example 3

The monitoring system 1 can be used in various situations. Monitoring system 1 may be used to provide Mobility as a Service (MaaS), a service that utilizes mobility.

### Other Embodiments

The above-described embodiments are merely examples, and the present disclosure may be appropriately modified and embodied without departing from its spirit. Furthermore, the processes and elements described in this disclosure can be freely combined and implemented as long as no technical contradictions arise.

In addition, the processing described as being performed by a single device may be shared and executed by multiple devices. Alternatively, the processing described as being performed by different devices may be executed by a single device. In a computer system, the hardware configuration (server configuration) realizing each function can be flexibly changed.

The present disclosure can also be implemented by supplying a computer program that implements the functions described in the above embodiments to a computer, and one or more processors of the computer reading and executing the program. Such a computer program may be provided to the computer via a non-transitory computer-readable storage medium connectable to the system bus of the computer, or may be provided to the computer via a network. A non-transitory computer-readable storage medium includes any type of medium suitable for storing electronic instructions, such as, for example, any type of disk, such as a magnetic disk (such as a floppy disk or a hard disk drive (HDD)), an optical disk (such as a CD-ROM, a DVD disk, or a Blu-ray disk), a read-only memory (ROM), a random-access memory (RAM), an EPROM, an EEPROM, a magnetic card, a flash memory, or an optical card.

What is claimed is:

1. An information processing apparatus including a controller comprising at least one processor configured to perform;
acquiring a number of standing passengers in a vehicle,
determining whether to execute a detection process of passengers moving inside the vehicle based on analysis of a moving image capturing the inside of the vehicle according to the number of standing passengers, and
outputting announcement information for making an in-vehicle announcement regarding movement inside the vehicle when the detection process detects a standing passenger moving inside the vehicle.

2. The information processing apparatus according to claim 1, wherein
determining whether to execute the detection process includes;
deciding to prohibit the execution of the detection process when the number of standing passengers exceeds a first threshold, and
deciding to execute the detection process when the number of standing passengers is less than the first threshold.

3. The information processing apparatus according to claim 1, wherein
the controller further configured to perform;
acquiring horizontal acceleration of the vehicle, and
determining whether to execute the detection process includes;
deciding to prohibit the execution of the detection process when the number of standing passengers exceeds a first threshold and the acceleration exceeds a predetermined value,
deciding to execute the detection process when the number of standing passengers exceeds the first threshold and the acceleration is less than the predetermined value, and
deciding to execute the detection process when the number of standing passengers is less than the first threshold.

4. The information processing apparatus according to claim 2, wherein
the outputted announcement information includes;
a first announcement to draw attention to behavior of the vehicle when the number of standing passengers exceeds a second threshold, which is the first threshold or less, and
a second announcement to encourage predetermined actions for safety when the number of standing passengers is less than the second threshold.

5. The information processing apparatus according to claim 2, wherein
outputting the announcement information includes limiting the number of times the announcement information is output within a predetermined period when the number of standing passengers exceeds a third threshold, which is the first threshold or less.

6. A method, by the at least one processor of the information processing apparatus according to claim 1, for improving travel mobility as a service (MaaS).
